(19) United States
(12) Patent Application Publication
(10) Pub. No.: US 2019/0121801 A1
(43) Pub. Date: Apr. 25, 2019

(54) Generating Recommendations Based on Semantic Knowledge Capture

(71) Applicant: GE Inspection Technologies, LP, Lewistown, PA (US)

(72) Inventors: Piyush Jethwa, San Ramon, CA (US); Arun Karthi Subramaniyan, Niskayuna, NY (US); Alexandre Nikolov Iankoulski, Livermore, CA (US)

(73) Assignee: GE Inspection Technologies, LP, Lewistown, PA (US)

(21) Appl. No.: 16/162,783

(22) Filed: Oct. 17, 2018

Related U.S. Application Data
(60) Provisional application No. 62/576,645, filed on Oct. 24, 2017.

(51) Int. Cl. G06F 16/242; G06F 16/332; G06F 16/901; G06F 16/33; G06F 16/36

(52) U.S. Cl. CPC G06F 16/243; G06F 16/3328; G06F 16/36; G06F 16/3334; G06F 16/9024

(57) ABSTRACT

Systems, methods, and a computer readable medium are provided for generating recommendations based on semantic knowledge capture. Event data generated by domain-specific entities can be received, formatted, and aggregated so that ontological mappings can be applied to generate domain-specific event data. The ontological mappings identify relationships associated with the event data generated by two or more communicatively coupled domain-specific entities. A graph can be generated based on the domain-specific event data and provided to a user via a GUI. The graph can include nodes representing domain-specific entities and a edges representing one or more contextual relationships between two or more nodes sharing event data. The user can provide query input via the GUI to generate an updated graph corresponding to the query input. Recommendations can be provided to the user based on the query input and the contents of the updated graph.

### CROSS-REFERENCE TO RELATED APPLICATIONS

The present application claims priority to U.S. Provisional Application No. 62/576,645 entitled “Framework For Providing Recommendations Based on Semantic Knowledge Capture,” filed on Oct. 24, 2017, which is hereby expressly incorporated by reference in its entirety.

### BACKGROUND

Creating and distributing domain-specific training materials can rely on software applications to receive, organize, store, and convey institutional knowledge to a variety of users. In some cases, content is provided using predefined templates and user interfaces associated with the software application used to store and convey the training materials. The training materials can be provided by users of varying expertise and do not always include input from domain experts having in-depth knowledge of the domain. In large multi-national enterprises, such as those operating in the oil and gas domain, localized knowledge specific to a piece of machinery, process, or software application deployed in those remote regions may not be distributed more broadly to other users in the enterprise outside of the remote regions. New hires, although possessing domain-specific education, can gain knowledge about the domain-specific machinery, process, or software by off-site training or job shadowing resulting in increased training costs and reduced productivity. In addition, job shadowing can be limited to specific aspects of a machine, process, or software application used in particular ways at any given location or project. Enterprises can develop best practices for collecting and disseminating training content, however providing training at a domain-expert-level on a wide range of topics, machines, processes, and/or software can be a non-trivial endeavor and can require a large amount of coordination and planning in large, often geographically distributed, organizations.

### SUMMARY

Developing and providing domain-specific training content to new and existing users of globally deployed machinery, processes, and/or software applications can be increasingly difficult. Domain-specific experts can be regionally localized and may not be available to contribute domain-specific training materials. For example, as software applications add new features and capabilities, users can have a difficult time gaining or maintaining proficiency using all of the features of the software application. In these situations, even routine configuration tasks can seem more difficult and error prone. This problem can be exacerbated in the industrial internet of things domain when large numbers of sensors and software applications may be used to monitor the operating parameters and condition of the deployed assets. Providing high-quality, domain-specific training content associated with these environments and the software applications used to manage them can be an increasingly difficult problem for large organizations.

An analytic engine can be used to execute features and functionality in multiple domain-specific software applications. The analytic engine can coordinate and deploy various analytic functions among the multiple domain-specific applications. The analytic engine can be coupled to a semantic knowledge calculator to create a system capable of collecting event data from the domain-specific applications. As the domain-specific applications are used the system can learn from the usage patterns and the applied analytic functions in order to generate recommendations that can be provided to users as training content. In this way, training content can be collected based on real-world usage of the domain-specific applications and/or the analytics applied to the applications. The training content can then be provided to users in a context that is specific to the user's objective instead of via pre-formatted, context unaware materials and user interfaces.

In general, systems and methods are provided herein for generating recommendations based on semantic knowledge capture. The recommendations can include training materials provided to a user in response to a user's input regarding a particular machine, process, or software application. The recommendations can be generated by collecting event data from domain-specific entities such as machines, sensors, services, and/or software applications. The event data can be processed using domain-specific ontological mappings in order to generate domain-specific event data. The domain-specific event data can then be used to generate a navigable graph including nodes representing domain-specific entities and edges representing associations or relationships between the domain-specific entities. The user can visualize and interact with the graph via a graphical user interface (GUI). The user can provide query input causing the graph to be re-rendered based on the query input. The GUI can further generate recommendations to the user based on the re-rendered graph. The recommendations can include training materials, but also executable functionality to be applied to the domain-specific entities and/or the associations between the domain-specific entities. In this way, a wide range of training content can be automatically captured and provided to a user in an interface allowing context-sensitive refinement and recommendation generation without requiring domain-experts to generate training materials on a case-by-case basis. By dynamically regenerating the graph and associated training materials and recommendations based on user input, users can explore a wider range of training topics than can be otherwise created and provided manually. In this way, a broader range of organizational knowledge can be shared throughout an organization with minimal input required from domain-experts using constrained formats and user interfaces. The system and methods described herein, can thus reduce training costs and improve the quality of training materials provided to users in a diverse, geo-graphically distributed organization.

In one aspect, a system for generating recommendations based on semantic knowledge capture is provided. The system can include a memory including instructions and a display including a graphical user interface (GUI). The system can also include one or more processors configured with executable instructions. The instructions, which when executed, can cause the processors to receive event data generated by one or more domain specific entities. The instructions, which when executed, can further cause the processors to format the received event data to confirm to a pre-defined format and aggregate the formatted event data. The instructions, which when executed, can also cause the processors to receive a plurality of ontological mappings and to apply the ontological mappings to the aggregated event data to generate domain-specific event data. The ontological mappings identifying one or more relationships associated with the vent data generated by two or more communicatively coupled domain-specific entities. The instructions, which when executed, can also cause the processors to generate a first graph based on the domain-specific event data using one or more visualization libraries. The first graph including a first plurality of nodes representing the one or more domain-specific entities and a first plurality of edges representing the one or more relationships between two or more nodes sharing event data. The instructions, which when executed, can further cause the processors to provide the first graph in a graphical user interface (GUI) and receive, via the GUI, a query input, the query input causing the processors to generate a second graph including a plurality of nodes and a plurality of edges associated with the query input. The second plurality of nodes and the second plurality of edges different than the first plurality of nodes and the first plurality of edges in the first graph. The instructions, which when executed, can further cause the processors to determine one or more recommendations based on the received query input and the nodes and edges in the second graph. The instructions, which when executed, can further cause the processors to provide, via the GUI, the one or more recommendations.

In another embodiment, the one or more processors of the system are further configured to receive the query input as a natural language search query and providing the one or more recommendations as a list of domain-specific entities and/or a list of contextual relationships corresponding to the received query input, the recommendations including auto-completion affordances to further determine the one or more recommendations.

In another embodiment, the one or more processors of the system are further configured to receive the query input as a selection of one or more graph rendering algorithms and generating the second graph based on the selected graph rendering algorithm.

In another aspect, methods for generating recommendations based on semantic knowledge capture are also provided. In one embodiment, the method can include receiving, by a processor, event data generated by one or more domain-specific entities. The method can also include formatting, by the processor, the received event data to conform to a pre-defined format and aggregating the formatted event data. The method can further include receiving, by the processor, a plurality of ontological mappings and applying one or more of the ontological mappings to the aggregated event data to generate domain-specific event data, the ontological mappings identifying one or more relationships associated with the event data generated by two or more communicatively coupled domain-specific entities. The method can also include generating, by the processor, a first graph based on the domain-specific event data using on one or more visualization libraries, the first graph including a first plurality of nodes representing domain-specific entities and a first plurality of edges representing one or more relationships between two or more nodes sharing event data. The method can further include providing the first graph in a graphical user interface (GUI) and receiving, via the GUI, query input, the query input causing the processor to generate a second graph including a second plurality of nodes and a second plurality of edges associated with the query input. The second plurality of nodes and the second plurality of edges different than the first plurality of nodes and the first plurality of edges. The method can also include determining, by the processor, one or more recommendations to be provided via the GUI based on the received query input and the second plurality of nodes and the second plurality of edges included in the second graph. The method can also include providing, via the GUI, the one or more recommendations.

In another embodiment, the method can also include receiving, by the processor, the query input as a natural language search query and providing the one or more recommendations as a list of domain-specific entities and/or a list of relationships corresponding to the received query input, the recommendations including auto-completion affordances to further determine the one or more recommendations.

In another embodiment, the method can also include receiving, by the processor, the query input as a selection of one or more graph rendering algorithms and generating the second graph based on the selected graph rendering algorithm.

In another embodiment, the GUI is configured to receive navigation input causing the first graph or the second graph to dynamically adjust the display of the first or the second plurality of nodes and first or the second plurality of edges based on the received navigation input.

In another embodiment, the first graph is automatically regenerated based upon receipt of new event data. In another embodiment, the new event data is received from an analytic engine as a result of configuring a domain-specific entity to be interfaced to the analytic engine or as a result of adding a feature to an existing domain-specific entity interfaced to the analytic engine.

In another embodiment, the one or more domain-specific entities include one or more domain-specific applications and the generated event data includes application programming interface invocations, web service invocations, microservice invocations, code executed in application GUIs, code executed in application back-ends, network cascaded events, user-triggered events, and scheduled events.

In another embodiment, the one or more domain-specific entities include an analytic engine. In another embodiment, the event data includes front-end reporting events and back-end reporting events. In another embodiment, the event data includes events generated based on execution of a single orchestration, execution of sequential orchestrations, and execution of non-sequential orchestrations.

In another embodiment, the received query input includes time and date criteria and the generated second graph displays the second plurality of nodes and the second plurality of edges based on the time and data criteria included in the query input.

In another aspect, a machine readable storage medium containing program instructions for generating recommendations based on semantic knowledge capture is also provided. The program instructions contained on the machine readable storage medium perform the method including receiving event data generated by one or more domain-specific entities. The program instructions also perform the method including formatting the received event data to conform to a pre-defined format and aggregating the formatted event data. The program instructions further perform the method including receiving a plurality of ontological mappings and applying one or more of the ontological mappings to the aggregated event data to generate domain-specific event data, the ontological mappings identifying one or more relationships associated with the event data generated by two or more communicatively coupled domain-specific entities. The program instructions also perform the method including generating a first graph based on the domain-specific event data, the first graph including a first plurality of nodes representing the one or more domain-specific entities and a first plurality of edges representing the one or more relationships between two or more nodes sharing event data. The program instructions further perform the method including providing the first graph in a graphical user interface (GUI) and receiving, via the GUI, query input, the query input received as a natural language search query and causing the processor to generate a second graph including a second plurality of nodes and a second plurality of edges associated with the query input. The second plurality of nodes and the second plurality of edges different than the first plurality of nodes and the first plurality of edges in the first graph. The program instructions also perform the method including determining a first one or more recommendations to be provided via the GUI based on the received query input and the second plurality of nodes and the second plurality of edges in the second graph. The program instructions also perform the method including providing, via the first one or more recommendations. The first one or more recommendations provided as a list of domain-specific entities and/or a list of relationships corresponding to the received query input and including auto-completion affordances to further determine a second one or more recommendations. The second one or more recommendations different than the first one or more recommendations.

### DESCRIPTION OF DRAWINGS

These and other features will be more readily understood from the following detailed description taken in conjunction with the accompanying drawings, in which:

FIG. 1 illustrates an example architecture for generating recommendations based on semantic knowledge capture;

FIG. 2 is a diagram illustrating a system overview for generating recommendations based on semantic knowledge capture;

FIG. 3 a is a block diagram illustrating the example client and server from the architecture of FIG. 1;

FIG. 4 is a diagram illustrating one exemplary embodiment of a method for generating recommendations based on semantic knowledge capture using the client/server of FIG. 1;

FIGS. 5A-5G are exemplary embodiments of a graphical user interface to generate recommendations based on semantic knowledge capture;

It is noted that the drawings are not necessarily to scale. The drawings are intended to depict only typical aspects of the subject matter disclosed herein, and therefore should not be considered as limiting the scope of the disclosure.

### DETAILED DESCRIPTION

Generating domain-specific training materials can be an important requirement for organizations seeking to educate and share knowledge between organization members or with outside contacts. New employees can often possess domain-specific education but lack domain-specific knowledge regarding specific pieces of equipment, processes or computer-related technology, such as applications, analytical models, or data-driven control or automation systems. Training materials are typically developed statically, in pre-defined formats, often by individuals who are not subject matter experts in a particular domain to which the training relates. In addition, subject matter or domain-specific experts can be occupied performing other projects and not available to develop domain-specific training materials for broad consumption within an organization. Dynamically generating domain-specific training materials can also be limited by the tools or software applications used to receive, process, and distribute the training materials. For example, creating documents or presentation slides of the training material can constrain the user to specific, pre-defined formats, and may not support dynamic exploration of various aspects or sub-topics that are related to the domain-specific training materials. The costs associated with training programs, for example class-room or presentation-based training, can be high and require coordination of specialized facilities to accurately emulate or provide real-life experience on a particular piece of equipment or software application. Shadowing or apprentice-like training can facilitate knowledge transfer about a specific aspect of a domain-specific piece of equipment or application but can also result in transfer of locally limited or tribal knowledge that may be pertinent in one context or location but may not be applicable on the same tools or application outside of the location where the training is occurring. In large, distributed multi-national enterprises, such as those in the oil and gas or energy production domains, providing personnel with the highest quality domain-specific training materials can be a non-trivial undertaking and can require a large degree of centralized planning and coordination to generate and disseminate the training materials effectively throughout the enterprise.

A training system is provided herein including systems, methods, and computer-readable mediums for generating recommendations based on semantic knowledge capture. The generated recommendations can facilitate user-driven, self-paced training and knowledge transfer of domain-specific knowledge and can enable a dynamic, explorative experience for users seeking to learn more about related aspects of the domain-specific knowledge. The recommendations can be generated in response to user input provided as queries. The queries can also cause the training system to generate a navigable graph that is contextually associated with the input query. The improved training system can generate the recommendations and the navigable graph based on receiving, formatting and aggregating event data generated from various domain-specific entities, such as equipment, processes or services, and/or software applications used throughout an organization or enterprise. The event data can be refined using ontological mappings to provide a more accurate, domain-specific characterization of the event data. The ontologically-mapped event data can then be used to construct a graph including domain-specific entities represented as nodes and contextual relationships between the domain-specific entities represented as edges between the nodes. The graph can be provided to a user in a graphical user interface (GUI) to allow exploration of the domain-specific entities and contextual relationships that can exist between the domain-specific entities. By interacting with the GUI and providing query input, the graph can be updated to display nodes and edges that are associated with the query input.

Based on the query input and the contents of the updated graph, the GUI can further generate recommendations associated with the query input and/or the nodes and edges in the updated graph. The recommendations can inform the user of various tasks, actions, analytics, evaluations, configurations or related functionality associated with the domain-specific entities corresponding to the query input. In this way, training materials can be autonomously collected based on real-world user interaction with the domain-specific entities without the need for subject matter experts to contribute training materials and content in pre-defined formats or based on specific training program schedules. A user querying the improved training system can be afforded a broader scope of training material than may otherwise be available based on the event data collected from the domain-specific entities. In addition, the GUI of the improved training system can provide a unique interface for generating recommendations and training materials related to query inputs associated with domain-specific entities. The GUI allows a user to navigate and explore a visual depiction of domain-specific entities and the context of the associations that can exist between them. As a result, users of the improved training system can explore and consume a broader array of training materials than may be provided by conventional methods, as well as receiving a richer training experience when evaluating or assessing related training content associated with the domain-specific entities corresponding to the user's query input.

Embodiments of systems and corresponding methods for determining a route plan identifying assets from which additional condition monitoring data is to be collected are discussed herein. However, embodiments of the disclosure can be employed for determining a route plan identifying assets based on a variety of asset attributes without limit.

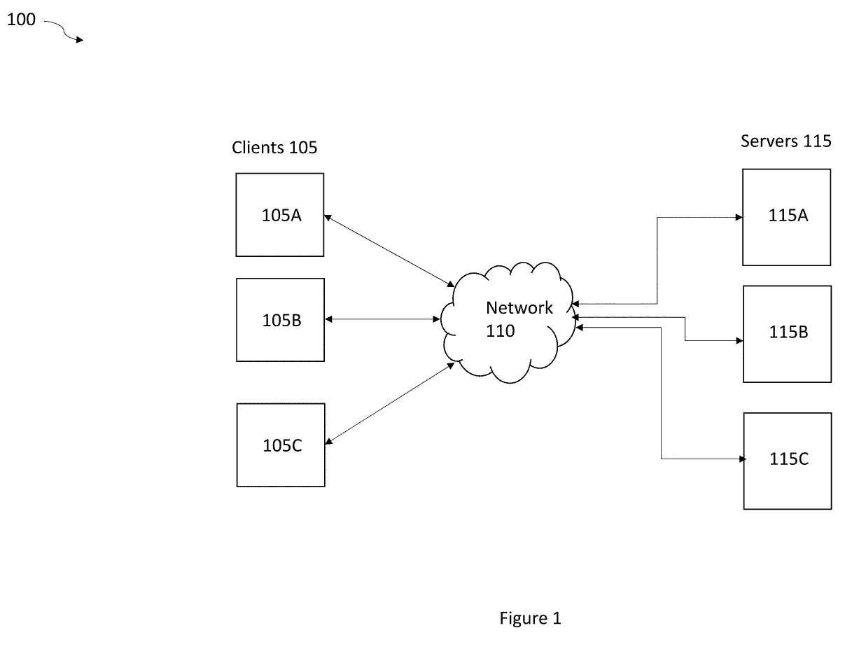

FIG. 1 is a diagram illustrating an example architecture 100 for generating recommendations based on semantic knowledge capture. The architecture 100 includes clients 105 and servers 115 connected over a network 110.

One of the servers 115 is configured to host a system for generating recommendations based on semantic knowledge capture. For purposes of load balancing, multiple servers 115 can be configured to host the system for generating recommendations based on semantic knowledge capture. As discussed herein, the system for generating recommendations based on semantic knowledge capture enables event data generated by domain-specific entities to be captured, processed and provided via a GUI so that users can interact with the GUI and receive recommendations associated with the domain-specific entities as training material. The recommendations can be dynamically determined based on query input provided by a user. The system, method, and computer-readable medium for generating recommendations based on semantic knowledge capture can be implanted within the exemplary architecture 100 shown in FIG. 1. Members of an organization or enterprise, can provide query input and receive recommendations using various types of client devices 105. For example, a user associated with Client 105A can interact with the training system hosted on one or more of the Servers 105 using a desktop computer. Client 105B can interact with the training system hosted on one or more of the Servers 105 using a tablet or portable computing device. Client 105C can interact with the training system hosted on one or more of the Servers 115 using a smart phone or other web-enabled wireless computing device. Based on query input provided by users of the client devices 105, the system can generate recommendations and training materials to be transmitted from the servers 115 to the client devices 105 over the network 110. The servers 115 generate the recommendations based on receiving, storing, and processing event data associated with one or more domain-specific entities. The servers 115 may include memory and one or more processors configured to execute instructions that when executed cause the processors to generate recommendations based on capturing and determining semantic knowledge associated with event data generated by domain-specific entities configured within the system.

The servers 115 can be any device having an appropriate processor, memory, and communications capability for hosting data encoder service. The clients 105 to which the servers 115 are connected over the network 110 can be, for example, desktop computers, mobile computers, tablet computers, mobile devices (e.g., a smartphone or PDA), or any other devices having appropriate processor, memory, and communications capabilities. In certain aspects, one or more of the servers 115 can be a cloud computing server of an infrastructure-as-a-service (IaaS) and be able to support a platform-as-a-service (PaaS) and software-as-a-service (SaaS) services.

The network 110 can include, for example, any one or more of a personal area network (PAN), a local area network (LAN), a campus area network (CAN), a metropolitan area network (MAN), a wide area network (WAN), a broadband network (BBN), the Internet, and the like. Further, the network 110 can include, but is not limited to, any one or more of the following network topologies, including a bus network, a star network, a ring network, a mesh network, a star-bus network, tree or hierarchical network, and the like.

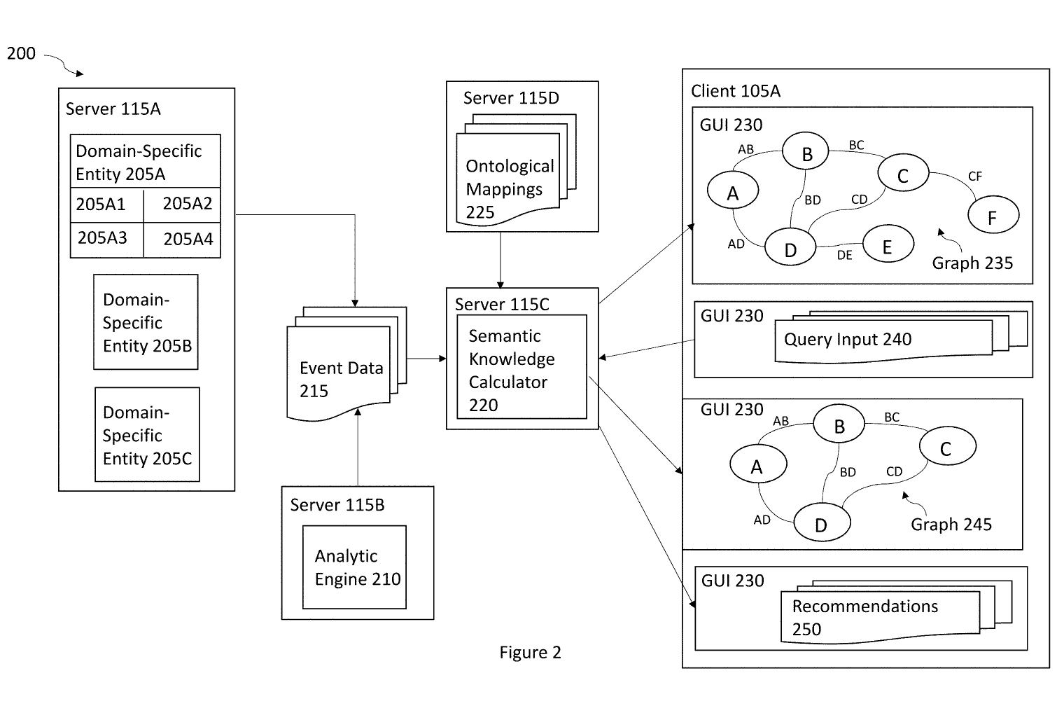

FIG. 2 is a diagram illustrating a system 200 for generating recommendations based on semantic knowledge capture. The client 105A and the servers 115A-115D are similar to the client 105 and the servers 115 described in the discussion of FIG. 1. As shown in FIG. 2, the system 200 includes multiple servers 115 and client 105A. Each of the servers 115 as shown in FIG. 2 are configured with different components and perform different functionality for the purposes of describing the various components and/or functionality of the system 200. The configuration shown in FIG. 2 is exemplary and not intended to be a limiting configuration of the system 200. In other embodiments, some or all of the components configured in each of the servers 115 can configured in a single server 115. It will be appreciated that a variety of server 115 configurations can be envisioned in the system 200.

As shown in FIG. 2, server 115A is configured with a plurality of domain-specific entities 205, for example, domain-specific entities 205A-205C. A domain-specific entity can include any entity in which event data can be generated, consumed or assigned. Domain-specific entities can include a piece of equipment, a collection of equipment, a sensor, a software application, a model, a GUI, a database or data structure, a service or microservice. The domain-specific entities 205 can be configured to include additional, associated domain-specific entities which are communicatively coupled to each other. For example, as shown in FIG. 2, the server 115A includes domain-specific entity 205A which can include further include additional domain-specific entities, such as domain-specific entity 205A1 which can be a controller which is operatively coupled to and configured to control two sensors (e.g., domain-specific entities 205A2 and 205A3) that are operatively coupled to a motor (e.g., domain-specific entity 205A4) in an oil and gas refinery or manufacturing facility. In addition, the server 115A also includes domain-specific entity 205B which can be a sensor monitoring application including a GUI to display the sensor data. The application, or domain-specific entity 205B can provide the sensor data via the GUI to a user and receive user input to configure one or more parameters of the sensor, such as the frequency at which sensor data is collected or alarm threshold levels associated with the sensor data. In addition, the server 115A also includes domain-specific entity 205C which can be a database of historical time-series sensor data. The domain-specific entity 205C can further include operating parameter reference standards used to define when the operating conditions of the motor are outside of expected tolerances thus indicating the motor is experiencing a fault condition and an alarm should be generated. Each of the domain-specific entities 205A-205C generate event data based on user or system driven actions that are performed in regard to the controller, the application, and/or the database (e.g., between the domain-specific entities 205A-205C).

In some embodiments, the domain-specific entities 205 can include equipment, machinery or industrial assets used to perform operations specific to the domain, such as the oil and gas domain. The domain-specific entities 205 can include individual machines, for example compressors or motors, as well as components of individual machines, such as a compressor shaft or a motor power supply. Typically, in oil and gas energy production environments, the domain-specific entities 205 can include a large variety of rotating or reciprocating equipment such as a motor, a gas turbine, a heat exchanger, a centrifugal pump, a centrifugal compressor, a fan, a reciprocating compressor, a generator, a steam turbine, a wind turbine, a portion of pipe, an axial compressor, a screw compressor, a gear, a turbo expander, a blower, an agitator, a mixer, a pulp refiner, a ball mill, a crusher, a pulverizer, an extruder, a pelletizer, and a cooling tower. The domain-specific entities 205 can be deployed in industrially hazardous environments making it difficult to safely assess the condition or state of the asset by collecting condition monitoring data from the asset in a direct, hands-on manner. Sensors can be configured to interface with the domain-specific entities and provide sensor data identifying measurements of the operational parameters of the domain-specific entities 205. The sensors can also be a domain-specific entity 205 configured to operate with the training system 200.

As further shown in FIG. 2, the system 200 includes server 115B which is configured with an analytic engine 210. The analytic engine 210 can be operatively coupled to the domain-specific entities 205. The analytic engine 210 can include a program or programs which can be configured to process event data and determine mappings between the domain-specific entities 205 generating the event data. In this way, the analytic engine 210 can define relationships between the domain-specific entities 205 which can be represented as edges in a knowledge graph. The analytic engine 210 can process the event data to determine an entity generating the event data (e.g., a subject), an entity to which the event data is directed toward or received by (e.g., an object), as well as the semantic or contextual relationship (e.g., an invocation or call) between the generating entity and the receiving entity. In some embodiments, the analytic engine 210 can store the mappings or relationships it has determined based on the event data in a specific format, such as a resource definition framework (RDF) format.

Additionally, or alternatively, the analytic engine 210 can be used to execute features and functionality of the domain-specific entities, such as domain specific entities 205A-205C as well as other computing entities which can be coupled to the training system. The features and functionality to be executed by the analytic engine 210 can be referred to as orchestrations. The analytic engine 210 can generate event data associated with a single orchestration, as well as sequential orchestrations or non-sequential orchestrations. An orchestration can represent a single analysis or objective as well as a particular workflow to be performed in regard to a specific analysis or task. Orchestrations can also be connected in a sequence, such as a recursive loop in which multiple variants of input data are evaluated in an optimization process. In some embodiments, the domain-specific entities can use capabilities of the analytic engine 210 to offer new capabilities, features or services. The analytic engine 210 can also generate event data based on user or system driven actions that are performed in regard to the analytic engine 210. In addition, the analytic engine 210 can generate event data corresponding to the domain-specific entities 205 to which it can be operatively coupled.

As shown in FIG. 2, the domain-specific entities 205 and the analytic engine 210 generate event data 215. The system 200 can be configured using an event-driven architecture capable of producing, detecting, consuming, reacting to and processing events. The event data 215 can include data corresponding to an event. An event is an action or occurrence that can be recognized by software and is generated by a user or by a system, application, or combination thereof. For example, user driven events can include mouse clicks, window-resizing, keyboard presses, joystick movements, touch events or gestures input into a touchscreen, messages from other programs or applications, and events associated with devices such as shaking, tilting, rotating, or moving the device. In user interfaces, events can include action selection, timer expirations, mouse movements, menu selections. The event is an entity, such as a message, which includes the action as well as the contextual variables triggering the action. System driven events can include application programming interface (API) invocations, service and/or microservice invocations, network-cascading events, execution of internal processes, interrupts generated by the domain-specific entities 205 and/or message passing between domain-specific entities 205. Additionally, or alternatively, events can define a significant change in state of a domain-specific entity 205 and/or the analytic engine 210, for example the execution of a single analytic or a predefined sequence of analytics.

As further shown in FIG. 2, the event data 215 is received by the semantic knowledge calculator 220 configured on server 115C. Additionally, the semantic knowledge calculator 220 also receives ontological mappings 225 from server 115D. The semantic knowledge calculator 220 formats and aggregates the received event data 215 and applies the ontological mappings 225 to the aggregated event data. The ontological mappings 225 provides domain-specific semantic descriptions and contextual associations for the domain-specific entities 205, such as types and properties, as well as the relationships between the domain-specific entities 205. For example, the ontological mappings 225 can be considered a domain-specific schema or dictionary that is applied to the aggregated event data in order to define and characterize the events in a domain-specific context. A plurality of ontological mappings 225 can be received such that each data set of ontological mappings 225 corresponds to one or more domain-specific entities 205. The ontological mappings 225 can be applied to the aggregated event data to generate domain-specific event data.

As shown in FIG. 2, the semantic knowledge calculator configured on server 115D generates a graph 235 for display in the GUI 230 of client 105A. The graph 235 is generated based on the domain-specific event data using one or more visualization libraries used for visualizing complex networks. For example, the visualization libraries can include graph theory libraries cable of displaying and manipulating rich, interactive graphs or data visualizations. One exemplary visualization library is a JavaScript library called Cytoscape.js. The Cytoscape.js library is an open-source library including functions for graph analysis and interactivity that can be integrated with client event data. A second exemplary visualization library is a JavaScript library called D3.js. The D3.js library is an open-source library including functions that allow binding data to Document Object Model (DOM) elements to provide interactive, web-based user interfaces. The DOM elements can then be selected, based on selection criteria, allowing smooth data transitions in reaction to events such as mouse clicks or mouse-overs, etc.

As shown in FIG. 2, the graph 235 includes a plurality of nodes, for example nodes A-F, representing the domain-specific entities 205 that are associated with the received event data 215. The graph 235 also includes a plurality of edges, for example AB, BC, CF, AD, BD, CD, and DE representing relationships between the nodes. The graph 235 can be considered a knowledge graph and represents all of the nodes and relationships associated with the event data 215 received from the domain-specific entities 205 and/or the analytic engine 210. The graph 235 can be continually updated as additional event data 215 is received by the semantic knowledge calculator 220. In some embodiments, the graph 235 is updated periodically on a pre-defined schedule. In other embodiments, the graph 235 is updated in near real-time. As new event data is received new usage patterns can be captured in the graph 235 as new nodes and/or edges are added to the graph 235 based on the new event data. By continually updating the graph 235 based on new event data, the system 200 can avoid storing all of the received event data 215 and can thus operate with less memory and data storage capacity than if all of the event data 215 were to be stored.

The system 200 allows usage patterns of equipment, application, or services to be collected and evaluated to provide insight about users, domain-specific entities 205, models, orchestrations and system components of the analytic engine 210. Over time, as usage patterns evolve, the graph 235 is continually updated without requiring periodic event data uploads or software updates. The system 200 can thus provide greater understanding of the operational metrics of the system such as identifying bottlenecks, critical components, expected and aberrant user behavior, and anomalies. Additionally, the system 200 can enable a better understanding of the usage patterns associated with the domain-specific entities 205 that can be used to provide unambiguous insight into product roadmap and/or usability or design considerations for the domain-specific entity.

Returning to the earlier example configuration of the domain-specific entities 205A-205C, and continuing the discussion of FIG. 2, the graph 235 can include nodes and edges corresponding to the event data 215 generated by the controller (e.g., domain-specific entity 205A1), the two sensors that are communicatively coupled to the controller (e.g., domain-specific entities 205A2 and 205A3), as well as the motor to which the sensors are interfaced (e.g., domain-specific entity 205A4). The graph can also include nodes corresponding to the sensor monitoring application (e.g., domain-specific entity 205B), and the database of sensor data (e.g., domain-specific entity 205C). The graph 235 can also include nodes and edges corresponding to the event data 215 received from the analytic engine 210. For example, node A can represent the controller (e.g., domain-specific entity 205A1) and nodes B and C can represent two sensors which are coupled to the controller and interfaced to the motor (e.g., domain-specific entity 205A2 and 205A3). Node D can represent the motor (e.g., domain-specific entity 205A4) to which the two sensors are communicatively coupled to collect operating parameter data associated with the motor. Node E can represent the sensor monitoring application (domain-specific entity 205B) and node F can represent a calibration model included in the database of sensor data (domain-specific entity 205C).

The graph 235 can be generated by the semantic knowledge calculator 220 based on the event data 215 received from the domain-specific entities 205 and the analytic engine 210. Based on processing the event data by applying the ontological mappings 225 to generate domain-specific event data, a network of domain-specific entities 205 associated with the domain-specific event data, represented as nodes, and relationships between the nodes, represented as edges, can be generated as graph 235. The edges can describe a variety of relationships that can exist between the nodes. For example, the edges can include usage patterns, associations, attributes, membership, or contexts related to the association between two or more nodes such as have/are assigned to, have role definitions/belongs to, has one or more of, use/add up to, consume/are consumed by, is a class/is a member of a class, is a type of, have role definitions/belongs to, upload/uploaded by, publish/published by, configure/configured by, select/selected by, test/tested by, deploy/deployed by, save/saved by, read/read by, write/written by, execute/executed by, contains/is part of, visualized/are rendered by, and are mapped to/are used by.

Additional edge types can be described in regard to user-related events or system-related events. One example of user-related edge type can include event data generated by a web browser in response to a user selecting a link displayed on a web site. In this example, upon selection of the link, the web browser redirects the user to a new web site. The edge can represent the result of the selecting the link, for example the redirection to the new web site. In a second example of user-related edge types, a user can interact with a visualization, such as a graph within a knowledge training system, such as the training system described herein, to receive recommendations. In this example, the user may select a recommendation from among an ordered list of recommendations. The selected recommendation can cause a domain-specific entity to implement or execute a function associated with the operation of the domain-specific entity. For example, upon selecting a recommendation to start a well motor in an oil and gas production system, the training system can generate event data associated with executing control functions to provide power to the well motor and initiate operation of the well motor.

System-related edge types can include relationships associated with system-to-system interactions. For example, in a deployment of microservices, an initial user input may trigger a series of events between multiple disparate microservice components. Event data can be generated as the microservice components are called by other microservice components and the edge type can describe the attributes of the invocations or calls between the microservice components, such as synchronous calls or asynchronous calls.

In some embodiments, the edge types can represent combinations of system-related events and user-related events. For example, a monitoring system configured to monitor a well pump that is producing oil or gas in an energy production operation can receive alerts when the pump operating conditions are outside of specified ranges. The event data generated by the monitoring system can include measures of criticality to enable a user to validate that the alarm is accurate or to confirm the alarm is a false positive. A user can thus elect to ignore or suppress the false positive alarm data. The edge types in this example can include system-related edge types relating to the alerts generated by the monitoring system, as well as user-related edge types relating to the suppression of alarms including certain measures of criticality for which the user determined the alerts were false positives. The action of the user to suppress the alarm can be event data that is provided back to the training system so that the training system can learn to suppress alarms for such events in the future (and thereby reduce the generation of edge types related to such events), making the training system a self-learning and more efficient training system.

Continuing the previous example, the graph 235 includes multiple edges, such as edge AB, AD, BD, BC, CD, DE and CF, each of which can describe a relationship or usage pattern associated with the two nodes that the edge corresponds to. For example, edge AB connects node A (e.g., the controller, described as domain-specific entity 205A1) and node B (e.g., one of the sensors, described as domain-specific entity 205A2). Similarly edge AD connects node A and node D (e.g., the motor, described as domain-specific entity 205A4). The edge AB can represent the context in which event data is passed between the controller (node A) and the sensor (node B). Edge AB can define, a relationship between the controller and the sensor such as configures/is configured by. Similarly edge AD can represent the context in which event data is passed between the controller (node A) and the motor (node D) such as controls operation/operation is controlled by. In this way the graph 235 can describe all nodes and relationships that can exist between nodes in a graph provided to the user in a GUI, such as GUI 230. The graph 235 can be navigable, or browsable, by a user to zoom in/out, reposition, and can enable interactive exploration of information related to the nodes and/or edges in the graph 235. For example, a user can click on node A and view information associated with the controller (e.g., domain-specific entity 205A1). Additionally, or alternatively, by clicking on edge AD, a user can receive information describing the context in which the operation of the motor (node D) is determined or performed by the controller (node A).

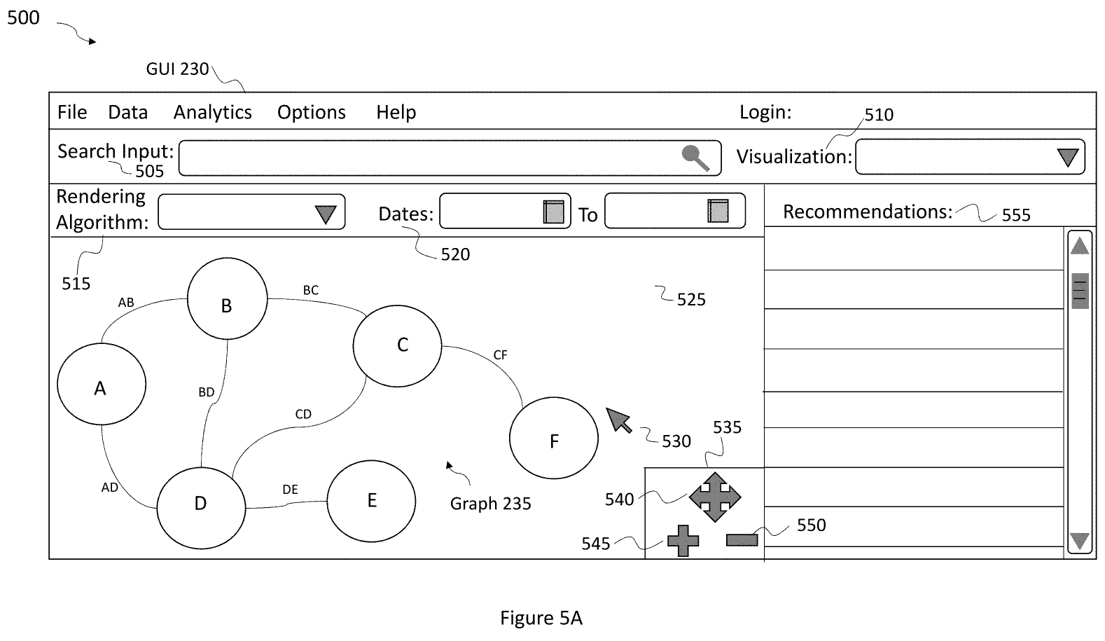

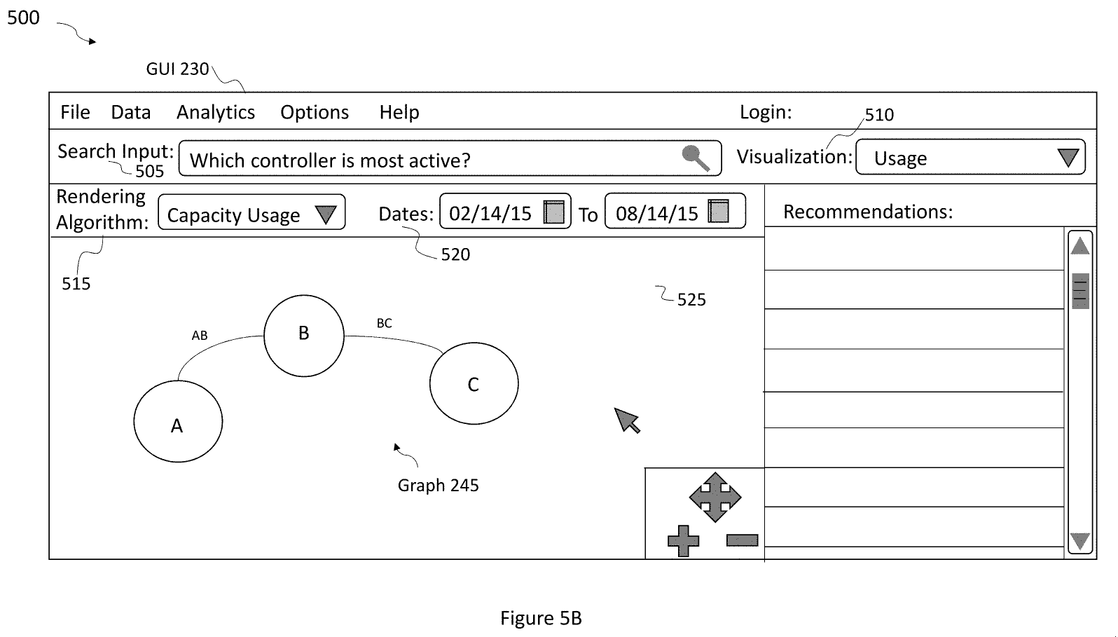

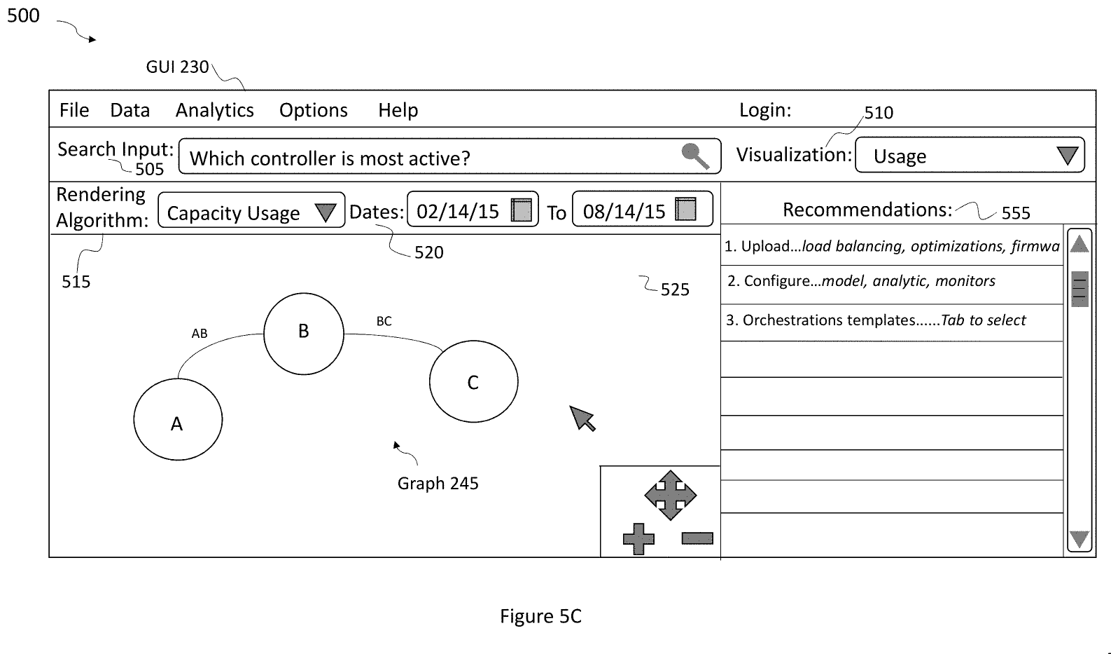

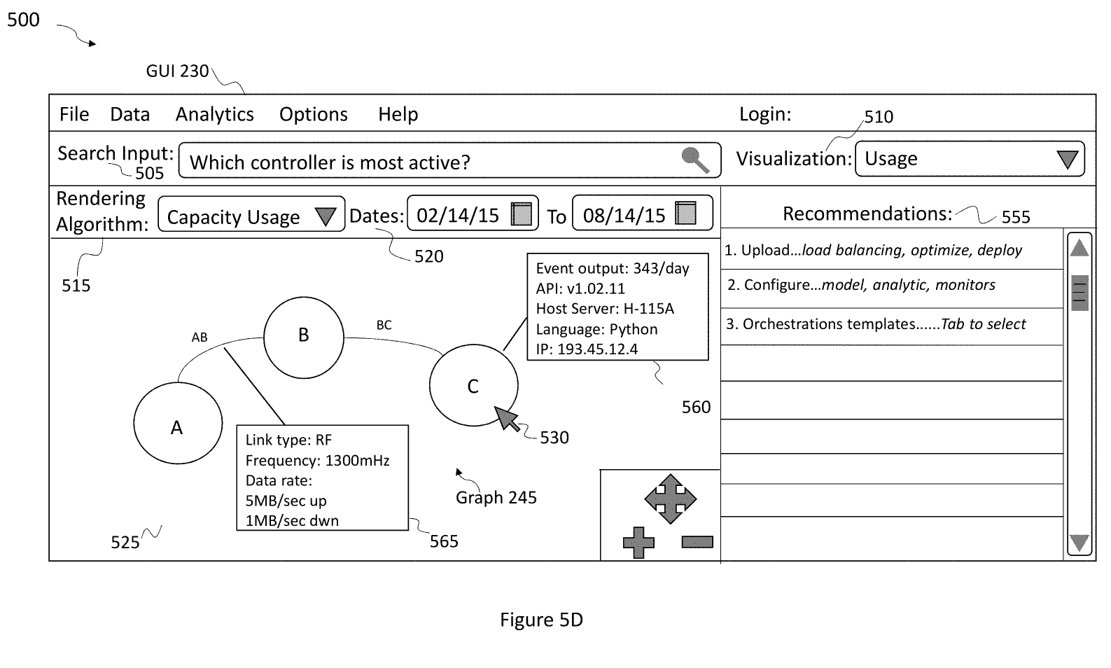

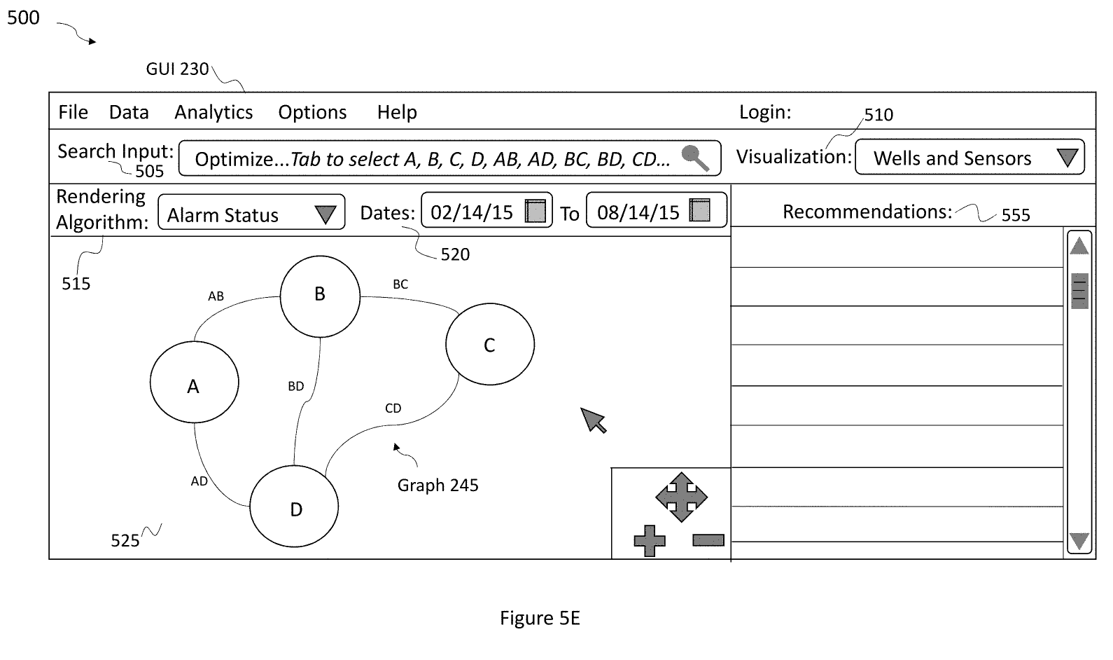

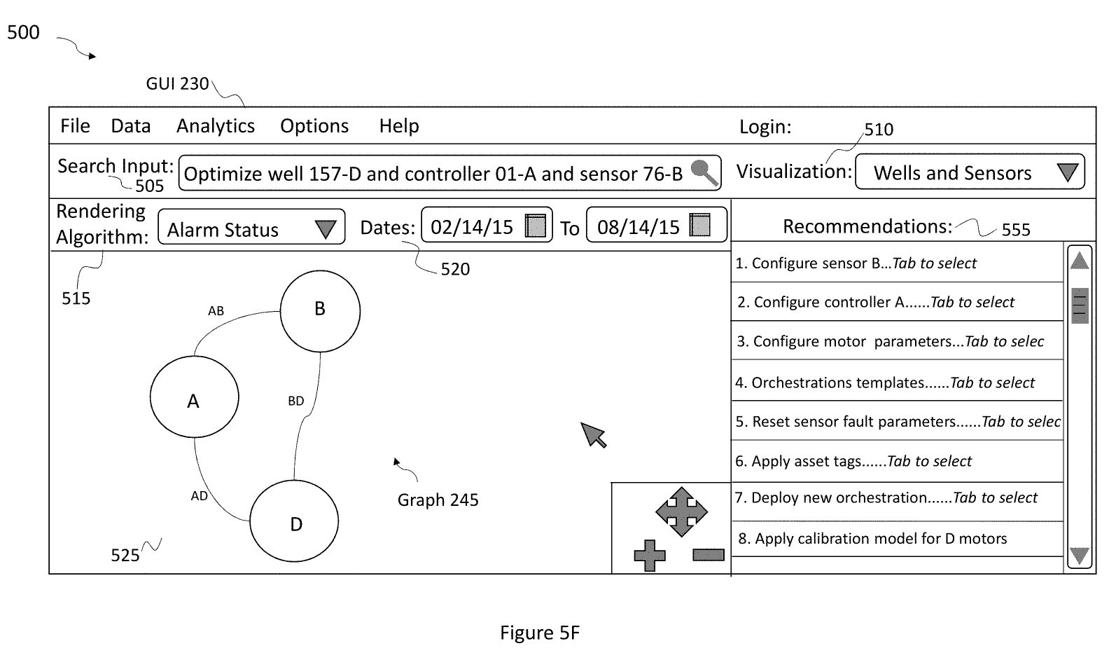

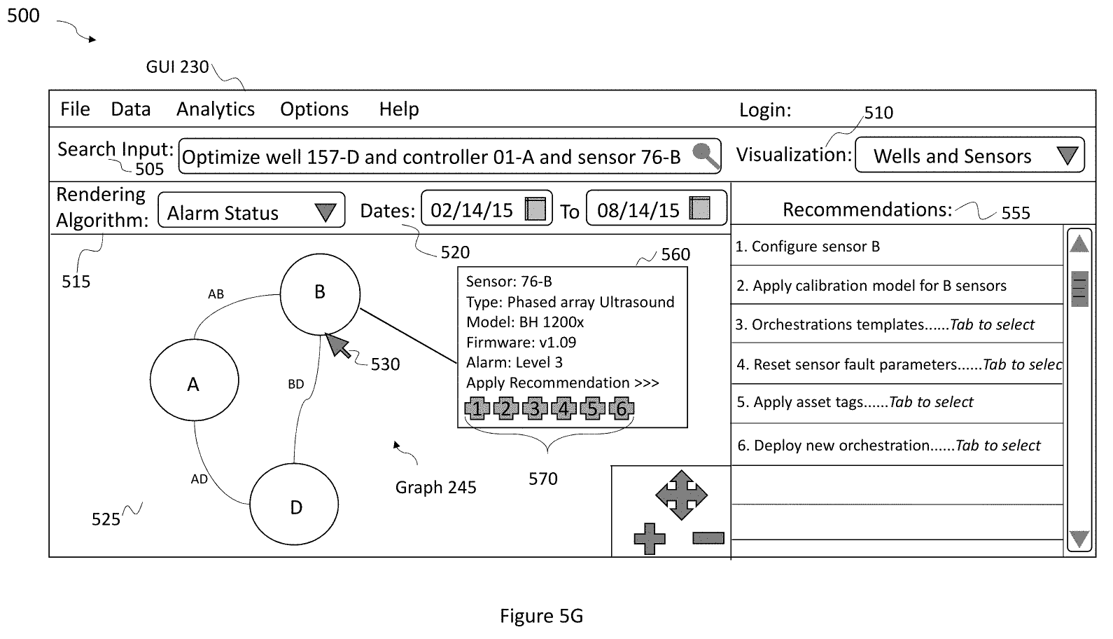

As further shown in FIG. 2, the GUI can receive query input 240. The input 240 can include input associated with the user's intended training objective. Based on viewing the graph 235, the user can explore and receive training content or recommendations that is associated with subset of the graph 235 by providing query input 240. The query input 240 can include voice, text, navigation, and gesture-based input. For example, using a mouse to move a cursor in the GUI 230, a user can crop or select a portion of the graph 230 so that recommendations can be generated based on the nodes and edges contained within the selected region. In some embodiments, the user can provide the query input 240 as textual input in the GUI 230. For example, the GUI 230 can include a search field to receive the query input 240. The user can input terms or partial terms and upon entry of the input, the semantic knowledge calculator 220 can generate an updated graph 245 based on the query input 240. In some embodiments, the query input 240 can include a natural language search query, such as a question or using verbs to describe actions and/or relationship for which the user seeks recommendations or training material. In some embodiments, the query input 240 can include time and date criteria input describing a particular range of date and time in which the event data should be filtered for inclusion in the graph 245. In some embodiments, the query input 240 can include visualization input causing the graph 245 to be visualized in a particular content. In some embodiments, the query input 240 can include rendering algorithm input causing the graph 245 to be rendered in a particular manner or based on applying a particular rendering algorithm. Further description of the GUI 230, the query input 240 will be discussed later in relation to FIGS. 5A-5G.

As shown in FIG. 2, the graph 245 can be generated based on the received query input 240. In some embodiments, the graph 245 can be dynamically generated or regenerated based on more, less, or different query input 240. The graph 245 includes the nodes and edges that are associated with the context of the query input 240. For example, continuing the previous example above, upon receiving textual query input 240 relating to the current shaft vibration parameter of the motor (e.g., node D), the GUI 230 can provide the query input 240 to the semantic knowledge calculator 220 which can generate graph 245 depicting only the nodes associated with the query input 240. In this example, and based on the query input corresponding to the current shaft vibration parameter of the motor, the graph 245 includes nodes A-D and the edges AB, AD, BD, BC, and CD. Nodes E and F and the edges corresponding to those nodes can be excluded from graph 245 because the semantic knowledge calculator 220 can determine that the sensor monitoring application (e.g, node E representing domain-specific entity 205B) and the calibration model included in the database of sensor data (e.g., node F representing domain-specific entity 205C) are not associated with the query input 240 describing the current shaft vibration parameter of the motor. As a result, the semantic knowledge calculator 220 generates the graph 245 including only those nodes and edges related to the query input 240.

As further shown in FIG. 2, the semantic knowledge calculator 220 can generate one or more recommendations 250. The semantic knowledge calculator 220 can generate the recommendations 250 based on the received query input 240 and the generated graph 245. The recommendations 250 can include training material to allow a user to gain greater insight as to the nodes (e.g., the domain-specific entities 205) and/or the edges (e.g., the relationships or usage patterns existing between the nodes based on the event data) in the graph 245. The recommendations 250 can be provided in the GUI 230. The recommendations 250 can include auto-completion affordances to allow a user to select one or more variants or related aspects of a recommendation. In some embodiments, the recommendations 250 can include models to be used with or applied to domain-specific entities 205, models to use next when creating or using an orchestration, or identify asset tags to use when deploying a model or an orchestration. Over time, the recommendations 250 can become more accurate as more event data is collected. The recommendations 250 can enable a user to perform difficult tasks more easily by providing a contextually accurate suggestion for next steps, actions, or additional information thereby reducing errors to perform the suggestion. The recommendations 250 can help novice users perform sophisticated tasks without requiring additional, expensive domain-specific training or requiring job shadowing with subject matter experts. In this way, best practices can be automatically collected and provided to users in a self-serve manner so that users in one part of an enterprise can learn or be trained from users in other parts of the enterprise. The system 200 and the generated recommendations 250 can reduce training costs for onboarding new employees, reduce the need for on-going training, and can provide a mechanism for rapidly disseminating best practices throughout a large, distributed multi-national enterprise. Further description of the recommendations 250 will be discussed later in relation to FIGS. 5A-5G.

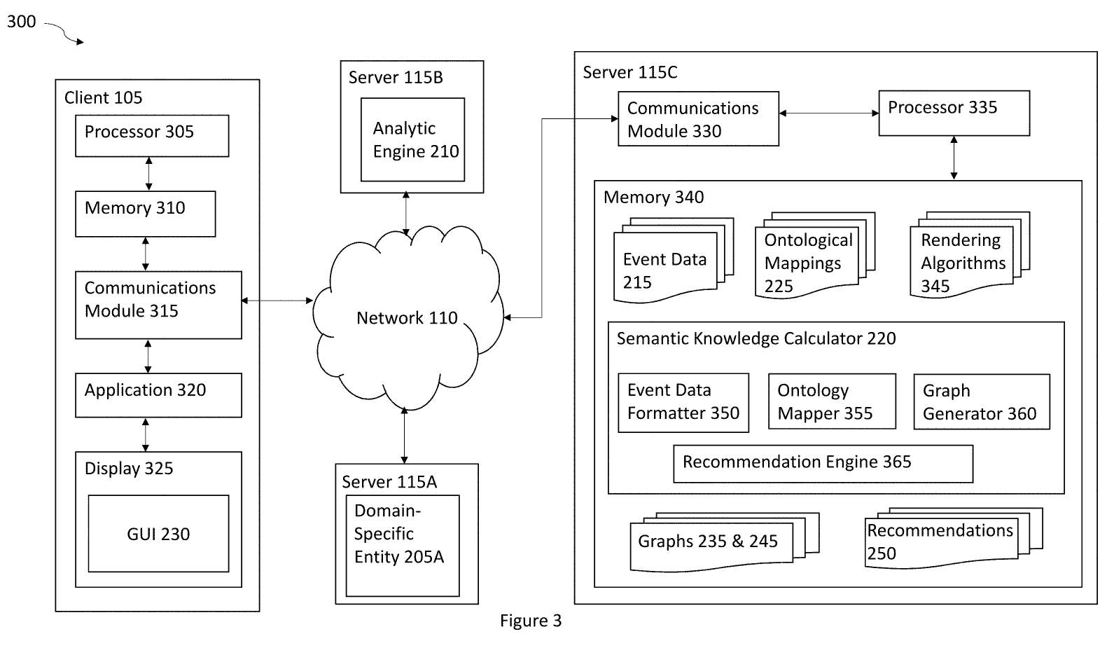

FIG. 3 is a block diagram illustrating the example client and server from the architecture of FIG. 1 in an exemplary training system 300. The block diagram of the training system 300 includes an example client 105 and server 115 similar to the client and server described in relation to architecture 100 of FIG. 1 according to certain aspects of the disclosure.

The client 105 and the server 115, e.g., server 115C are connected over the network 110 via respective communications modules 315 and 330. The communications modules 315 and 330 are configured to interface with the network 110 to send and receive information, such as events, event data, event message, usage pattern data, requests, responses, and commands to other devices on the network. The communications modules 315, and 330 can be, for example, modems or Ethernet cards.

The server 115C includes a processor 335, a communications module 330, and a memory 340 that includes one or more machine readable storage mediums containing program instructions for causing a computer to generate recommendations based on semantic knowledge capture. The processor 335 of the server 115C is configured to execute instructions, such as instructions physically coded into the processor 335, instructions received from software in memory 340, or a combination of both. For example, the processor 335 of the server 115C executes instructions to generate recommendations based on semantic knowledge capture of event data associated with one or more domain-specific entities that may be output to application 320 for display on client 105 in the GUI 230 of display 325. The server 115C also includes a memory 340 configured with one or more data content modules to store event data 215, ontological mappings 225, and rendering algorithms 345. The rendering algorithms 345 can be used to visualize the network of nodes and edges in one or more ways. The memory 340 of server 115C is also configured with one or more data processing modules to receive and process event data, generate knowledge graphs and recommendations. The memory 340 includes a semantic knowledge calculator 220 capable of receiving event data and query input transmitted from servers 115 and client devices 105, respectively. The semantic knowledge calculator 220 includes an event data formatter 350 to format the received event data using one or more pre-defined formats and aggregate the formatted event data. The semantic knowledge calculator 220 also includes an ontology mapper 355 configured to apply ontological mappings 225 to the aggregated event data in order to generate domain-specific event data. The semantic knowledge calculator 220 also includes a graph generator 360. The graph generator applies the rendering algorithms to the domain-specific event data to generate graphs 235 and 245. The semantic knowledge calculator 220 also includes a recommendation engine 365 configured to generate recommendations and training material based on the generated graphs 235 and 245 as well as in response to query input 240. The memory 340 of server 115C is further configured with one or more data content modules to store graphs 235 and 245 as well as recommendations 250. Previously determined versions of the graphs 235 and 245 as well as previously determined versions of the recommendations 250 can be input to the semantic knowledge calculator 220 to generate more accurate graphs and recommendations in the future based on the previously determined graphs and recommendations. Memory 340 can output the graphs 235 and 245 as well as the recommendations 250 to processor 335 and communication module 330 for transmission to the client 105. Once received, the client 105 can provide the graphs 235 and 245 as well as the recommendations 250 to a user for display in the GUI 230 that is configured in display 325.

The client 105 includes a processor 305, the memory 310, and the communications module 315. The memory 310 includes application 320. For example, application 320 may include a web browser, a training application, a condition monitoring application, a domain-specific application, a modeling and simulation application or environment, or a data analysis application. Application 320 may include, but is not limited to, any application used in an organization to receive, manage, and/or disseminate training materials or recommendations intended to train users in regard to a domain-specific entity, technology, process, or method. The client 105 also includes an input device (not shown), such as a keyboard or a mouse. The processor 305 of the client 1005 is configured to execute instructions, such as instructions physically coded into the processor 305, instructions received from software in memory 310, or a combination of both. For example, the processor 305 of the client 105 executes instructions to transmit query input generated from or received at the client device 105 to server 115C for storage and processing to generate recommendations based on semantic knowledge capture. In some embodiments, the application 320 and/or the client 105 can include a knowledge agent or an interactive agent, such as a chatbot program that is configured to receive training or query inputs and provide the inputs to server 115 so that recommendations related to the inputs are generated and returned to a user interacting who is with the chatbot program.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

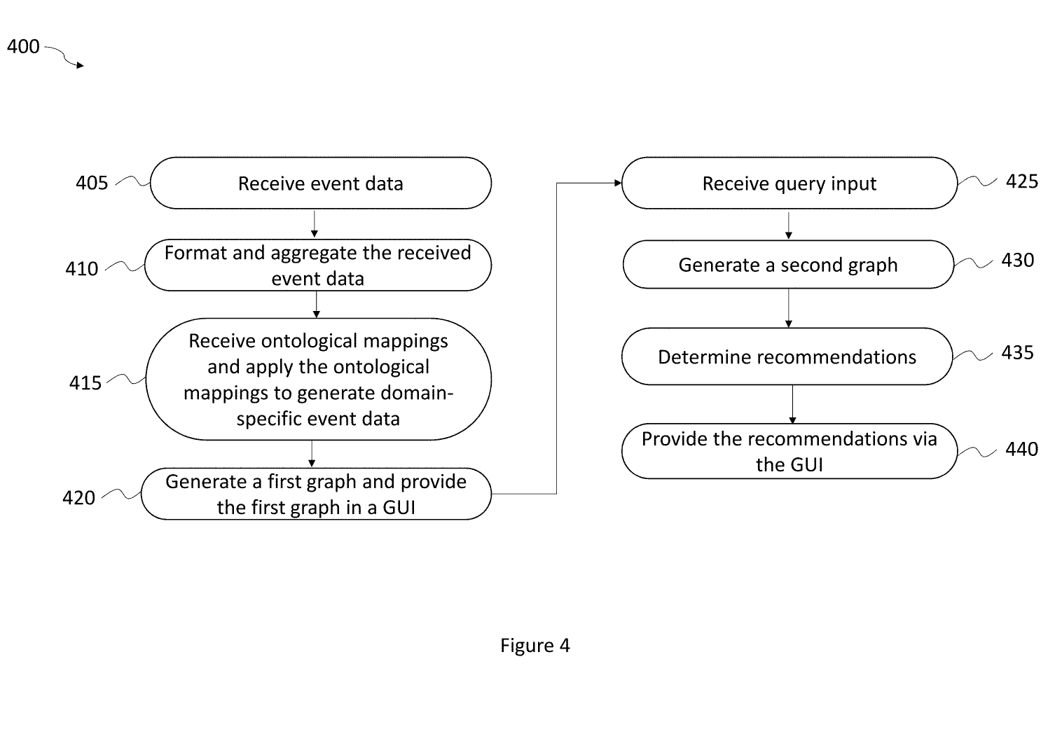

FIG. 4 is a flow diagram illustrating an exemplary embodiment of a method 400 for generating recommendations based on semantic knowledge capture using the client/server of the training system 300 as shown and described in relation to FIG. 3. In certain aspects, embodiments of the method 400 can include greater or fewer operations than illustrated in FIG. 4 and the operations can be performed in a different order than illustrated in FIG. 4.

For example, in operation 405, the semantic knowledge calculator 220 receives event data 215 generated from the domain-specific entities 205. The received event data can be further processed in operation 410 where the event data formatter 350 can format the received event data according to one or more predefined formats. The predefined formats may be stored in memory 340 and used to convert, alter or otherwise confirm the received event data into a format that is more readily usable for aggregation of event data, application of ontological mappings 225, or generation of graphs 235 and/or 245. The event data formatter 350 can further aggregate the formatted event data prior to further processing.

In operation 415, the semantic knowledge calculator 220 receives ontological mappings 225 and applies the ontological mappings 225 to generate domain-specific event data. The raw event data generated by the domain-specific entities 205 and the aggregated event data formatted by the event data formatter 350 may not include the domain-specific attributes or characterizations necessary to generate a network graph depicting the domain-specific entities 205 (e.g., as nodes) and the context of the relationships between the domain-specific entities 205 (e.g., as edges). Thus, the semantic knowledge calculator 220 includes an ontology mapper 355 configured to apply ontological mappings 225 to the aggregated event data. The ontological mapper 355 can process the aggregated event data using one or more look up tables, heuristics, or search and replace mechanisms to generate domain-specific event data that can be used to generate a knowledge graph associated with the domain-specific entities. In some embodiments, the ontology mapper 355 can receive the ontological mappings 225 from the memory 340, as shown in FIG. 3. In some embodiments, the ontological mappings 225 can be stored on one server 115 and received by the semantic knowledge calculator 220 on a different server 115, as shown in FIG. 2.

In operation 420, the semantic knowledge calculator 220 generates a first graph and provides the first graph in a GUI. Based on generating the domain-specific event data, the graph generator 360 configured within the semantic knowledge calculator 220 can use one or more visualization libraries to generate a graph, such as knowledge graph 235 in a GUI, such as GUI 230. The visualization libraries can be stored in memory 340 or can be stored on one or more servers 115 that are communicatively coupled to the server 115 configured with the semantic knowledge calculator 220. The GUI 230 can include a portion of the interface for displaying the graph 235 and can also include a portion of the interface configured with graphical affordances, icons, and/or widgets associated with functionality to visually manipulate or navigate the graph within the GUI 230 based on user input. Further discussion of the GUI 230 will be described in relation to FIGS. 5A-5G.

In operation 425, the GUI 230 receives query input. The query input, such as query input 240 described in relation to FIG. 2, can include voice, textual or graphical input that is provided by a user in regard to a particular training topic, domain-specific entity 205, or orchestration associated with the analytic engine 210. The user can provide the query input 240 to refine the graph 235 thereby narrowing, broadening, or otherwise altering the scope of the domain-specific entities and the relationships between them that are presented in the GUI 230. The query input 240 can enable a user to specify the training topics or knowledge that the user seeks to gain a better understanding based on the event data 215 and the domain-specific entities 205 represented in graph 235. In some embodiments, the query input 240 can include time and data criteria. In some embodiments, the query input 240 can be received as natural language search queries. In some embodiments, the query input 240 can include a selection of graph rendering algorithms. In some embodiments, the query input 240 can include auto-completion mechanisms or affordances to complete partial query input 240 and/or provide related query input that is associated with the initially provided query input.

In operation 430, the semantic knowledge calculator 220 generates a second graph. Based on receiving query input 240, the graph generator 360 configured within the semantic knowledge calculator 220 can apply one or more visualizations libraries to generate an updated graph, such as graph 245 shown in FIG. 2. The second graph 245 can be generated in similar manner as graph 235, but the semantic knowledge calculator 220 further receives and processes the query input 240 to generate the updated second graph 245. In this way, the graph 245 represents the domain-specific entities 205 and their relationships that specifically correspond to the user provided query input 240.

In operation 435, the semantic knowledge calculator 220 determines recommendations. Based on the domain-specific entities included in graph 245 and/or the query input 240, the recommendation engine 365 that can be configured within the semantic knowledge calculator 220 determines recommendations by issuing queries or running algorithms against the knowledge graph 245. In some embodiments, the recommendations are determined using a query language or a semantic query language, such as SPARQL which is a recursive acronym describing a Resource Description Framework (RDF) query language. A RDF query language is an exemplary semantic query language for databases that is able to retrieve and manipulate data stored in RDF formats. SPARQL allows for queries which can include triple patterns or triplestores, conjunctions, disjunctions, and optional patterns. In some embodiments, the recommendations can be determined using similarity-based algorithms, such as minimal distance algorithms, clustering algorithms, and/or nearest neighbor algorithms. The determined recommendations can be tasks, suggestions, executable or callable functionality, and/or domain-specific assets that are most semantically or contextually relevant to the domain-specific entities included in graph 245 and/or the query input 240. The recommendations can include auto-completion mechanisms or affordance to allow a user to further select from one or more variants related to a particular recommendation. For example, a recommendation can include a suggestion to optimize a well model for a well that is included in the domain-specific entities 205 that are included in the graph 245. The recommendation engine can generate a recommendation to optimize a well model and the recommendation can further include or suggest multiple optimization techniques that can be applied to optimize the well model in a specific manner. In some embodiments, the determined recommendations can be stored in memory 310 of the client 105 or the memory 340 of the server 115C.

In operation 440, the semantic knowledge calculator 220 provides the recommendations via the GUI. The user can view the recommendations 250 and take further action based on the recommendations 250 in GUI 230 of client 105. The GUI 230 can include a predefined interface or include a user-configurable interface for viewing the recommendations 250 and/or the graph 235 and 245. Further discussion of the GUI 230 will be described in relation to FIGS. 5A-5G.

FIGS. 5A-5G are exemplary embodiments 500 of a graphical user interface to generate recommendations based on semantic knowledge capture. FIGS. 5A-5G illustrate a GUI 230 configured within an improved training system, such as training system 200 of FIG. 2. The GUI 230 illustrated in FIGS. 5A-5G and the embodiments described or illustrated therein correspond to operations 420-440 of method 400 described in relation to FIG. 4. In some embodiments, the GUI 230 can include additional or fewer graphical affordances, which may or may not be illustrated, but are described, to perform the operations of method 400. FIGS. 5A-5G can describe a GUI, such as GUI 230, to receive input from a user, however, the GUI 230 can also receive input from a computer via electronic communication between computers executing computer-readable instructions to provide input into the GUI 230. The GUI 230 shown in FIGS. 5A-5G can be configured to execute instructions, upon receipt of input from a user or a computer, which initiate processing or execution of further functionality on an electronically coupled computer that may or may not be illustrated, but is described in relation to GUI 230 of the training system 200 illustrated in FIGS. 5A-5G.

The GUI 230 shown in FIGS. 5A-5G illustrates an improved user interface for providing training materials, enabling knowledge transfer, and disseminating information about a domain-specific topic or related topic. The improved interface can include graphical affordances to provided selections for data analysis and visualization functionality which, upon selection, can provide a user or electronically coupled computer with increased data comprehension, reduced processing time, improved data rendering and data visualization in a graphical application environment, and faster modeling and simulation of domain-specific entities. As a result, users and electronically coupled computers can receive data and information, as training materials in the form of the recommendations 250, which can improve the users understanding of domain-specific subject matter and improve the operations or functionality of the domain-specific entities 205.

As shown in FIG. 5A, the GUI 230 is illustrated in a state of operation corresponding to operation 420 described in relation to FIG. 4. In operation 420, the semantic knowledge calculator 220 can generate a first graph and provide the first graph in a GUI. The GUI 230, shown in FIG. 5A can be implemented in client-hosted application or in a web-based application hosted remotely and accessed via a web browser. The GUI 230 can include menu selections for file management (e.g., “File”), data import/export/management (e.g., “Data”), executing functionality related to analytics or the analytic engine 210 (e.g., “Analytics”), user and system configured preferences or options affecting the display or operation of the GUI 230 (e.g., “Options”), accessing technical documentation or interactive assistance regarding operation of the GUI 230 or the training system 200 (e.g., “Help”), and authentication and access functionality identifying a user or administrator as a credentialed user of the GUI 230 and/or the training system 200 (e.g., “Login”).

As shown in the non-limiting examples illustrated in FIG. 5A, the GUI 230 includes interface affordances such as fields, menus, selections and input mechanisms for providing multiple forms of query input 240 via a search input 505, a visualization input 510, a rendering algorithm input 515, and a date criteria input 520. The GUI 230 includes a display panel 525 and a cursor 530. The GUI 230 includes a navigation control panel 535 which includes a display control 540, a zoom-out control 545 and a zoom-in control 550. The GUI 230 includes a recommendation panel 555.

The discussion of FIGS. 5A-5G will include use of the previously provided example described in relation to FIGS. 2, 3, and 4. It can be assumed that in FIGS. 5A-5G, nodes A-F correspond to domain-specific entities 205A1-A4, 205B, and 205C, and edges AB, AD, BD, BC, CD, CF, and DE represent semantic or contextual relationships between the nodes. In the previous example and as will be described below continuing the example in regard to the functionality and operation of GUI 230, the GUI 230 includes node D (e.g., a motor representing domain-specific entity 205A4) operating in an oil and gas refinery or manufacturing facility. The GUI 230 also includes node A (e.g, a controller representing domain-specific entity 205A1). The GUI 230 includes nodes B and C (e.g., two sensors representing domain-specific entities 205A2 and 205A3, respectively). In addition, the GUI 230 includes node E (e.g., a sensor monitoring application representing domain-specific entity 205B) and node F (e.g., a calibration model included in the database of sensor data representing domain-specific entity 205C). The functionality and operation of the GUI 230 will be described in relation to one or more use cases for generating recommendations based on semantic knowledge capture using the event data 215 generated by domain-specific entities 205A1-4, 205B, and 205C as shown and described in relation to FIG. 2.

As shown in FIG. 5A, the GUI 230 displays a graph 235 in display panel 525. The graph 235 is generated based on the semantic knowledge calculator 210, specifically the graph generator 360, processing domain-specific event data and generating a first graph to be provided for display in a GUI, for example GUI 230, as described in relation to operation 420 illustrated in FIG. 4. In some embodiments, the graph 235 can be generated as a result of new event data 215 received from one or more domain-specific entities 205 and/or the analytic engine 210. The graph 235 can be generated using one or more visualization libraries that can be executed in regard to the event data 215 and produce a network graph, such as graph 235. Continuing the previous example, the semantic knowledge calculator 220 processes the received event data 215 and determines that the event data 215 has been received from the domain-specific entities 205 that are correspond to the motor (e.g., node D), two sensors interfaced to the motor (e.g., nodes B and C), the controller interfaced to the motor and the two sensors (e.g., node A), the sensor monitoring application (e.g., node E) and the calibration model included in the database of sensor data (e.g., node F). The semantic knowledge calculator 220, specifically the graph generator 360, can then generate the graph 235 corresponding to the domain-specific entities which have generated the received event data 215 and can provide the graph 235 for display in the display panel 525 of GUI 230.

As shown in FIG. 5B, and corresponding to operation 425 described in relation to FIG. 4, query input is received. One form of query input 240 can be provided to the GUI 230 by a user. In some embodiments another computer can provide the query input 240 to the GUI 230. In FIG. 5, query input 240 is received in the search input 505. The search input 505 can receive multiple forms of textual input that each include varying levels of semantic accuracy in regard to the intended query input. For example, the search input field can receive query input 240 including complete words, partial words, letters, sequences of letters and/or numerals, identifiers of domain-specific entities 205, complete and/or partial sentences, and complete and/or partial questions. In some embodiments, the query input 240 can include natural language search queries. In some embodiments, the query input 240 can include random combinations of complete words, partial words, letters, sequences of letters and/or numerals, identifiers of domain-specific entities 205, complete and/or partial sentences, and complete and/or partial questions. In some embodiments, the query input 240 provided in the search input 505 can originate from a knowledge or interactive agent (e.g., a chatbot program) that is configured to receive a user's inputs and provide those inputs as query inputs 240. As shown in FIG. 5B, the query input 240 provided in the search input 505 describes a query to identify which controller is most active (e.g., “Which controller is most active”). Upon entry of the query input 240 via the search query input 505, the graph 245 can be automatically generated or regenerated as described in relation to operation 430 of FIG. 4.

As further shown in FIG. 5B, the GUI 230 can receive another form of query input 240 to select a visualization library. The visualization input 510 provides a selection of visualization libraries, such as JavaScript visualization libraries, that can be applied to the domain-specific event data in order to generate a specific visualization of the nodes and edges to be depicted in the graph 245. For example, as shown in FIG. 5B, a visualization input selection of “Usage” has been provided to the visualization input 510. In some embodiments, the selections available via the visualization input 510 can be determined by the semantic knowledge calculator 220 based on the event data 215, the domain-specific entities 205 determined to be associated with the event data 215, as well as the query input 240 that is received via the search input 505. Continuing the previous example, it can be assumed a user is attempting to gain knowledge or training materials related to the activity or usage of the controller based on the query input 240 that has been provided in the search input 505 and the visualization selection made in the visualization input 510. Upon selection of the visualization library or visualization algorithm via the visualization input 510, the graph 245 can be automatically generated or regenerated as described in relation

As further shown in FIG. 5B, the GUI 230 includes rendering algorithm input 515 to receive another form of query input 240. The rendering algorithm input 515 can receive input to select a rendering algorithm. The rendering algorithm can be a data processing algorithm applied to the nodes and edges of the graph 245 to generate a version of the graph 245 that is optimized in a particular manner or context. The rendering algorithm can include image processing algorithms, graph theory algorithms, algebraic equations, mathematical solvers, and graphical rendering algorithms. In some embodiments, the rendering algorithms can include algorithms associated with the domain-specific entities 205 corresponding to the nodes and edges displayed in graph 245. For example, algorithms that can display a plurality of oil and gas wells in a cluster related to an operation performed by the well, or algorithms to display network traffic between organization data centers, or algorithms to display API calls and invocations to a server configured with hosted, license-authenticated modeling and simulation software used in energy production modeling.

In some embodiments, the rendering algorithm can include algorithms that are associated with the visualization selected in the visualization input 510. For example, as shown in FIG. 5B, the rendering algorithm selections can include selections that are configured to show a version of graph 245 that is a related association of the visualization input (e.g., “Usage) provided in the visualization input 510. In this example, “Capacity Usage” is provided for selection in the visualization input 510 and can be considered to be based on the “Usage” visualization input. In some embodiments, the rendering algorithm selections can include selections based on the query input 240 provided in the search input 505. For example, based on one or more sequences of characters in the search input 505, a rendering algorithm selection can be provided in the rendering algorithm input 515 corresponding to the query input 240. For example, a query input 240 including the word “controller” provided in search input 505, can cause the GUI 230 to provide a rendering algorithm selection related to controllers, and/or the operation of that domain-specific entity. Upon selection of the rendering algorithm via the rendering algorithm input 515, the graph 245 can be automatically generated or regenerated.

As shown in FIG. 5B, the GUI 230 includes a date criteria input 520 as another form of query input 240. The date criteria input 520 can include fields or input mechanisms, such as icons, or executable graphical affordances to enter calendar dates and units of time (not shown) that are used to determine the nodes and edges to be displayed in graph 245. The date criteria can cause the GUI 230 to display graph 245 based on domain-specific event data associated with a time frame provided in the date criteria input 515, such as a range of time between a “from” date and a “to” date. The date criteria input 520 can include additional, not shown, features for specifying a duration of time within a time-series data set. The date criteria input 520 can include features for controlling small measurements of time, such as millisecond and microsecond time scales, that may be applicable in viewing sensor event data for example. In some embodiments, the GUI 230 can include features related to playing, forwarding, reversing, pausing, stopping, starting, visual animations of graphical simulation models as the graph 245. The graphical simulation models associated with the domain-specific event data. Upon entry of the date criteria input via the date criteria input 520, the graph 245 can be automatically generated or regenerated.

Based on receiving a single form of query input 240 or a combination of the aforementioned forms of query inputs 240 provided in the search input 505, the visualization input 510, the rendering algorithm input 515, and/or the date criteria input 520, the GUI 230 can generate or regenerate the graph 245 in the display panel 525 according to operation 430 as described in relation to FIG. 4. The graph generator 360 can determine the plurality of nodes and edges to display in display panel 525 by applying a graph search algorithm to the graph 235 or using one or more visualization libraries. In some embodiments, a single form of query input 240 or a combination of the aforementioned forms of query inputs 240 provided in the search input 505, the visualization input 510, the rendering algorithm input 515, and/or the date criteria input 520 as an input to the graph search algorithm or the visualization libraries can be used to generate or regenerate the graph 245. The semantic associations determined by the graph generator 360 can inform the graph search algorithm or the visualization libraries of semantically or contextually associated domain-specific entities in the domain-specific event data associated with graph 235. The graph generator 360 can then generate an updated graph 245 based on the associated domain-specific entities 205 determined from graph 235 and/or any of the single or combination of inputs provided in the search input 505, the visualization input 510, the rendering algorithm input 515, and/or the date criteria input 520 in the GUI 230.

As shown in FIG. 5C, and corresponding to operation 435 described in relation to FIG. 4, recommendations are determined. The recommendations, such as recommendations 555, can include training material, frequently or commonly performed operations, suggestions, as well as operations or functionality that can be required to be applied or performed in relation to the domain-specific entities 205 identified in the graph 245. The recommendations 555 can identify documents, process steps, optimizations, services, analytics, models, data, or information that can be contextually or semantically related to the nodes and edges in the graph 245 as well as any of the single input or combination of inputs provided in the search input 505, the visualization input 510, the rendering algorithm input 515, and/or the date criteria input 520 in the GUI 230. In this way, the GUI 230 can provide an enhanced interface that improves a training experience by dynamically determining semantically or contextually relevant recommendations 555 that are associated with domain-specific entities 205

The recommendation engine 365 can determine the recommendations 555 to be provided in the GUI 230 based on the nodes and edges determined by the graph generator 360 to be included in and displayed in graph 245. In some embodiments, the recommendation engine 365 can determine the recommendations 555 based on the single or combination of inputs provided in the query input 240, the visualization input 510, the rendering algorithm input 515, and/or the date criteria input 520 in the GUI 230 in addition to the contents or graph 245. In some embodiments, the recommendation engine 365 can determine the recommendations 555 based only on the single or combination of inputs provided in the search input 505, the visualization input 510, the rendering algorithm input 515, and/or the date criteria input 520. The recommendations 555 can be generated dynamically in response to the generation of graph 245 and/or the regeneration of graph 245. In this way, if new query inputs are provided to any of the search input 505, the visualization input 510, the rendering algorithm input 515, and/or the date criteria input 520 in the GUI 230, the recommendation engine 365 can dynamically generate the recommendations 555. In some embodiments, the recommendations 555 can be provided to a user via a knowledge agent or an interactive agent, such as a chatbot program that can be configured to receive the recommendations 555 and provide them to a user in response to the user's query input 240 that was provided via the chatbot program. Additionally, or alternatively, the recommendation engine 365 can dynamically generate the recommendations based on a user manipulating the graph 245, for example, based on a user zooming in or zooming out of a portion of the graph 245. In some embodiments, the recommendation engine 365 can dynamically generate the recommendations based on repositioning the graph 245 within the display panel 525 to show a different view of one or more portions of the graph 245.

As shown in FIG. 5C, the recommendations 555 determined by the recommendation engine 365 include three recommendations (e.g., recommendations 1-3). Returning to the previous example, a user has entered query input 240 related to the activity of a controller and has selected to visualize controller usage via visualization input 510 and to apply a rendering algorithm associated with capacity usage in the rendering algorithm input 515. In addition the user has provided a date criteria via the date criteria input 520. Based on those inputs and/or the resulting nodes and edges determined to be included in the graph 245, the recommendation engine 365 can determine recommendations 555 that may be associated with the capacity usage of the controller (e.g., node A). For example, as shown in recommendation 1, the recommendation generator 365 can determine that a user may desire to perform an upload operation. As shown in italic font of recommendation 1, the recommendation engine 365 can further suggest additional related subject matter as further recommendations that can be related to the initial recommendation of “upload”. For example, the recommendation generator 365 can determine additional recommendations related to “upload” such as upload load-balancing models, upload (controller) optimizations, and upload (controller) firmware. Similarly, as shown in recommendation 2, the recommendation generator 365 has determined a second recommendation 555 can include knowledge, training materials, or operations related to configuring the controller, e.g., “configure”. For example, as shown in FIG. 5C, the recommendation generator 365 can determine associated recommendations for configuring a model, configuring an analytic, or configuring a condition monitor for the controller. In addition, the recommendation engine 365 can further determine a third recommendation 555, e.g., recommendation 3, to inform the user about “Orchestration templates” that may be applied to the controller.

The recommendations 555 can include an ordered list of recommendations as shown in FIG. 5C. In some embodiments the ordered list can be ranked based on the nodes and edges included in the graph 245 and/or the inputs provided to any of the search input 505, the visualization input 510, the rendering algorithm input 515, and/or the date criteria input 520. The recommendation engine 365 can determine the rank of the recommendations 555 such that the recommendations which are most strongly semantically or contextually associated with the graph 245 contents and/or the query inputs provided to any of the search input 505, the visualization input 510, the rendering algorithm input 515, and/or the date criteria input 520 are displayed as the first recommendation, e.g., recommendation 1, provided.

As shown in FIG. 5D, and continuing the previous example described above, the GUI 230 includes a cursor 530. A user can direct the cursor to one of the nodes, e.g., nodes A-C shown in graph 245 and select the node which can cause the GUI 230 to display node data in the node data panel 530 that is related to the node. Additionally, or alternatively, a user can hover the cursor 530 over or in sufficient proximity to the node C to cause the GUI 230 to consider the node C to be selected and to further cause the node data panel 560 to be automatically displayed. Upon selecting node C, the semantic knowledge calculator 220 executes functionality to provide a node data panel 560 for display. The node data included in the node data panel 560 can be associated with the domain-specific entity 205 that the node represents based on the event data 215 that was received by the semantic knowledge calculator 220. As shown in FIG. 5D, the node data panel 560 has been generated for node C. Node C corresponds to one of the two sensors (e.g., domain-specific entities 205A2 and 205A3) that are communicative coupled to the controller corresponding to node A (e.g., domain-specific entity 205A1).

The node data panel 560 illustrated in FIG. 5D, includes node data associated with the sensor corresponding to node C. The node data can include data a large variety of data that can be specific to or associated with the domain-specific entity for which the node corresponds to. For example, node C corresponds to a sensor which has been identified by the semantic knowledge calculator 220 as domain-specific entity 205A3. As such, the node data includes the sensor data rates, the API version number configured on the sensor, an identifier of the server hosting the sensor data, the programming language and the IP address that is configured on the sensor corresponding to node C.

As further shown in FIG. 5D, the GUI 230 includes an edge data panel 565. The edge data panel 565 can display edge data associated with the semantic or contextual relationship between two nodes that are connected by the edge. A user can similarly navigate a cursor to select or otherwise hover near or over an edge in the graph 245 and the semantic knowledge calculator can execute instructions to cause the edge data panel 565 to display edge data. The edge data can be associated with relationship of the nodes or the edge data can be associated with the domain-specific entities 205 corresponding to the nodes. For example as shown in FIG. 5D, the edge AB has been selected, and the GUI 230 displays the edge data panel 565. The edge data includes the type of communication interface (e.g., Link type: radio frequency (RF)) that is configured between node A (e.g., the controller identified as domain-specific entity 205A1) and node B (e.g., a sensor identified as domain-specific entity 205A2). The edge data also includes the communication frequency and the data rate corresponding to the RF link between the controller and the sensor. In this way, a user can use the GUI 230 to not only receive recommendations 555 as training input but to also simultaneously view node and edge data that is specific to the domain-specific entities 205 and the sematic or contextual relationships between them. Providing training data and domain-specific entity data in this improved interface, such as GUI 230, enables more efficient knowledge transfer or training in regard to the domain-specific entities 205 and also enables more efficient control and management of the functionality or operations of the domain-specific entities 205.

FIG. 5E illustrates a GUI 230 that is similar to the GUI 230 shown and described above in the discussion of FIGS. 5A-5D. The GUI 230 in FIG. 5E can be assumed to be in a state following the completion of operation 430 (e.g., generate a second graph) described in relation to FIG. 4. In this state, a user or computer coupled to the training system 200 has provided inputs to one or more of the search input 505, the visualization input 510, the rendering algorithm input 515, and/or the date criteria input 520 and the graph 245 has been generated.

As shown in FIG. 5E, the inputs illustrate a second exemplary embodiment of the query inputs 240 provided via search input 505. As shown in FIG. 5E, the user has provided a different query input in order to train or gain knowledge on a different or related aspect of the domain-specific entities 205 than previously described. In the previous described example discussed in relation to FIG. 5B, a natural language search query was provided as query input 240 to search input 505 regarding the activity of the controller. In the current example, now to be described in FIG. 5E, the user has changed the context of the training experience to learn more about how to optimize an aspect of the domain-specific entities 205. The user has provided an incomplete or partial search query that includes only the word “Optimize” in the search input 505. Additional inputs have also been provided, for example, the visualization input 510 has received a selection of “Wells and Sensors” and the rendering algorithm input 515 has received an input of “Alarm Status”. The date criteria input 520 remains unchanged from the previous example. It can be assumed, based on these new query inputs that the user is seeking to train or gain knowledge related to optimizing wells and/or sensors in regard to alarm status over a time period occurring between Feb. 14, 2015 and Aug. 14, 2015.

Based on the query input shown in FIG. 5E, the graph generator 360 has generated the graph 245 including nodes A-D and edges AB, AD, BC, BD, CD according operation 430 of FIG. 4. The semantic relevance and contextual association of the query inputs can be determined by the graph generator 360 and processed to generate graph 245 including only those domain-specific entities which may be semantically or contextually related to the query inputs. As shown the graph generator 360 has determined that the combination of inputs are more associated with the domain-specific entities corresponding to the motor (node D), the controller (node A), and the two sensors (nodes B and C) than the sensor monitoring application (node E) and/or the calibration model included in the dataset of sensor data (node F). As a result, the graph generator 360 has excluded nodes E and F from the graph 245.

In some embodiments, the search input 505 can include auto-completion mechanisms. For example, as shown in the search input 505, after entering the input term “Optimize”, the semantic knowledge calculator 220 can cause the GUI 230 to display semantically or contextually related node and edge data which has been determined as being most associated with the initial search term of “Optimize”. The GUI 230 can display the additional node and edge selections to the user in the search input 505 for selection, for example using a tab key to complete the selection for one or more of the nodes and/or edges. The improved training system 200 user interface shown in GUI 230, and specifically the auto-completion mechanisms configured in the search input 505, enable a user to efficiently explore and select domain-specific entities or their relationships in order to receive training or gain additional knowledge in a desired context.

In FIG. 5F, the GUI 230 has received additional query input via the auto-completion mechanisms configured in the search input 505 to indicate that the user is seeking to optimize a well (e.g., “well 157-D”, corresponding to node D), a controller (e.g., “controller 01-A, corresponding to node A) and a sensor (e.g., “sensor 76-B”, corresponding to node B). As a result, the graph generator 360 has generated an updated graph 245 as described in relation to operation 430 of FIG. 4. Based on the additional query inputs provided in search input 505, the graph generator can determine that node C is no longer semantically or contextually associated with the inputs and has generated an update graph 245 excluding node C.

As further shown in FIG. 5F, based on the regenerated graph 245 and the query inputs, recommendation engine 365 has determined recommendations 555 as described in relation to operation 435 of FIG. 4 and provided the recommendations 555 via the GUI 230 as described in relation to operation 440 of FIG. 4. The recommendation engine 365 has determined that recommendations 1-8 are most semantically and contextually related to the inputs provided in the search input 505, the visualization input 510, the rendering algorithm input 515 and the date criteria input 520 as well as the nodes and edges displayed in graph 245. The recommendations 555 include training suggestions or recommendations to configure the sensor B, the controller A, and the motor parameters. The recommendations 555 also include recommendations to access and apply orchestration templates and reset sensor fault parameters. In addition, the recommendation engine 365 has determined that recommendations related to applying asset tags, deploying new orchestrations, and applying a calibration for D-type motors are semantically or contextually related to the query inputs and the nodes and edges included in graph 245.

In FIG. 5G, the GUI 230 has received a node selection from the user via the cursor 530. The query inputs remain the same as discussed above, however, based on the user's interaction with node B, the recommendation engine 365 has regenerated the recommendations 555. The recommendation engine 365 has determined the most semantically or contextually related suggestion or training materials in regard to the selection of node B by the user. For example, the list of recommendations 555 can include suggestions, training materials or recommendations that affect the operation of the sensor corresponding to node B. Additionally, or alternatively, the recommendation engine 365 can also be configured to generate recommendations based on the selection of an edge between two nodes. Upon selection of an edge, the recommendation engine 365 can generate recommendations that are most associated with the semantic or contextual relationships represented by the edge and occurring between two nodes or the domain-specific entities 205 to which the nodes correspond.

As further shown in FIG. 5G, based on selecting node B, the semantic knowledge calculator 220 executes functionality to provide the node data panel 560 associated with node B for display. As described above, the node data panel 560 can include node data which is associated with the domain-specific entity corresponding to the node. For example, based on selecting node B, the node data panel 560 can display the node data such as the sensor identifier, the sensor type, the model of the sensor, the firmware version the sensor is configured with, and the alarm level that is configured on the sensor. As further shown in the node data panel 560, the node data can include recommendation application input 570. The recommendation application identifiers 570 can include mechanisms or executable graphical affordances to apply one or more of the recommendations 555. For example, a user can select an icon corresponding to one of the recommendations 555 and the GUI 230 will execute instructions to perform, initiate, provide or otherwise implement the recommendation 555 corresponding to the selected icon of the recommendation application input 570. In the example shown in FIG. 5G, selecting the cross-shaped icon with the “1” inside would implement the recommendation to “Configure sensor B”. In this way, the GUI 230 of the improved training system 200 enables a user to quickly apply recommendations or training materials associated with a particular domain-specific entity 205.

Exemplary technical effects of the methods, systems, and devices described herein include, by way of non-limiting example, generating training materials and recommendations based on semantic knowledge capture and processing of event data that is generated by domain-specific entities without requiring storing of all of the initially generated event data. By generating a graph data structure based on only newly received event data, less memory and fewer computing resources can be used to generate the recommendations. Thus the system represents an improvement of computer functionality that processes and displays graph data and recommendations that represent a limited set of data. In this way, the improved training system 200 can provide faster, more accurate training experiences in a dynamic graphical user interface capable of automatically regenerating the graph and recommendations without requiring additional input other than the query input. Additionally, the improved GUI provides more efficient execution of recommendations by error-proof mechanisms when selecting a recommendation to apply to a domain-specific entity, such as the recommendation application input 570. Existing training systems typically include static presentations of the training materials and lack the ability to dynamically receive, process, and generate updated training materials for display in a navigable display that affords context-sensitive updating and regeneration of the displayed content based on the query inputs provided by a user. The improved training system provides a more intuitive display of the training materials and allows for a deeper understanding of the recommendations and graph contents.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method comprising:
receiving, by a processor, event data generated by one or more domain-specific entities;
formatting, by the processor, the received event data to conform to a pre-defined format, and aggregating the formatted event data;
receiving, by the processor, a plurality of ontological mappings and applying one or more of the ontological mappings to the aggregated event data to generate domain-specific event data, the ontological mappings identifying one or more relationships associated with the event data generated by two or more communicatively coupled domain-specific entities;
generating, by the processor, a first graph based on the domain-specific event data using one or more visualization libraries, the first graph including a first plurality of nodes representing the one or more domain-specific entities and a first plurality of edges representing the one or more relationships between two or more nodes sharing event data;
providing the first graph in a graphical user interface (GUI) and receiving, via the GUI, a query input, the query input causing the processor to generate a second graph including a second plurality of nodes and a second plurality of edges associated with the query input, the second plurality of nodes and the second plurality of edges different than the first plurality of nodes and the first plurality of edges in the first graph;
determining, by the processor, one or more recommendations based on the received query input and the second plurality of nodes and the second plurality of edges included in the second graph; and
providing the one or more recommendations.

2. The method of claim 1, wherein providing the one or more recommendations includes displaying the recommendations within the GUI, storing the recommendations, transmitting the recommendations, and/or providing the recommendations for further processing.

3. The method of claim 1, wherein the GUI is configured to receive navigation input causing the first graph or the second graph to dynamically adjust the display of the first or the second plurality of nodes and the first or the second plurality of edges based on the received navigation input.

4. The method of claim 1, wherein the first graph is automatically regenerated based upon receipt of new event data.

5. The method of claim 4, wherein the new event data is received from an analytic engine as a result of configuring a domain-specific entity to be interfaced to the analytic engine or as a result of adding a feature to an existing domain-specific entity interfaced to the analytic engine.

6. The method of claim 1, wherein the one or more domain-specific entities include one or more domain-specific applications and the generated event data characterizes application programming interface invocations, web service invocations, microservice invocations, code executed in application GUIs, code executed in application back-ends, network cascaded events, user-triggered events, and scheduled events.

7. The method of claim 1, wherein the one or more domain-specific entities include an analytic engine.

8. The method of claim 1, wherein the event data includes front-end reporting events and back-end reporting events.

9. The method of claim 1, wherein the event data includes events generated based on execution of a single orchestration, execution of sequential orchestrations, and execution of non-sequential orchestrations.

10. The method of claim 1, wherein the received query input includes time and date criteria and the generated second graph displays the second plurality of nodes and the second plurality of edges based on the time and data criteria included in the query input.

11. The method of claim 1, further comprising:
receiving the query input as a natural language search query; and
providing the one or more recommendations as a list of domain-specific entities and/or a list of relationships corresponding to the received query input, the recommendations including auto-completion affordances to further determine the one or more recommendations.

12. The method of claim 1, further comprising:
receiving the query input as a selection of one or more graph rendering algorithms; and
generating the second graph based on the selected graph rendering algorithm.

13. The method of claim 1, wherein the one or more recommendations include a model recommended for use with specific domain-specific entities, a model recommended for use when creating an orchestration, and/or an asset tag recommended for use when deploying a domain-specific entity or an orchestration.

14. A system comprising:
a memory comprising instructions;
a display including a graphical user interface (GUI); and
one or more processors configured to execute instructions, which, when executed, cause the one or more processors to:
receive event data generated by one or more domain-specific entities;
format the received event data to conform to a pre-defined format and aggregate the formatted event data;
receive a plurality of ontological mappings and apply one or more of the ontological mappings to the aggregated event data to generate domain-specific event data, the ontological mappings identifying one or more relationships associated with the event data generated by two or more communicatively coupled domain-specific entities;
generate a first graph based on the domain-specific event data using one or more visualization libraries, the first graph including a first plurality of nodes representing the one or more domain-specific entities and a first plurality of edges representing the one or more relationships between two or more nodes sharing event data;
provide the first graph in a graphical user interface (GUI) and receive, via the GUI, query input, the query input causing the processor to generate a second graph including a second plurality of nodes and a second plurality of edges associated with the query input, the second plurality of nodes and the second plurality of edges different than the first plurality of nodes and the first plurality of edges in the first graph;
determine one or more recommendations to be provided via the GUI based on the received query input and the nodes and edges in the second graph; and
providing the one or more recommendations.

15. The system of claim 14, wherein providing the one or more recommendations includes displaying the recommendations within the GUI, storing the recommendations, transmitting the recommendations, and/or providing the recommendations for further processing.

16. The system of claim 14, wherein the GUI is configured to receive navigation input causing the first graph and/or the second graph to dynamically adjust the display of the second plurality of nodes and the second plurality of edges based on the received navigation input.

17. The system of claim 14, wherein the first graph is automatically regenerated based upon receipt of new event data.

18. The system of claim 17, wherein the new event data is received from an analytic engine as a result of configuring a domain-specific entity to be interfaced to the analytic engine or as a result of adding a feature to an existing domain-specific entity interfaced to the analytic engine.

19. The system of claim 14, wherein the one or more domain-specific entities include one or more domain-specific applications and the generated event data characterizes application programming interface invocations, web service invocations, microservice invocations, code executed in application GUIs, code executed in application back-ends, network cascaded events, user-triggered events, and scheduled events.

20. The system of claim 14, wherein the one or more domain-specific entities include an analytic engine.

21. The system of claim 14, wherein the event data includes front-end reporting events and back-end reporting events.

22. The system of claim 14, wherein the event data includes events generated based on execution of a single orchestration, execution of sequential orchestrations, and execution of non-sequential orchestrations.

23. The system of claim 14, wherein the received query input includes time and date criteria and the generated second graph displays the second plurality of nodes and the second plurality of edges based on the time and data criteria included in the query input.

24. The system of claim 14, wherein the one or more processors are further configured to:
receive the query input as a natural language search query; and
provide the one or more recommendations as a list of domain-specific entities and/or a list of relationships corresponding to the received query input, the recommendations including auto-completion affordances to further determine the one or more recommendations.

25. The system of claim 14, wherein the one or more processors are further configured to:
receive the query input as a selection of one or more graph rendering algorithms; and
generate the second graph based on the selected graph rendering algorithm.

26. A machine readable storage medium containing program instructions, which when executed cause one or more processors to performed the method of:
receiving event data generated by one or more domain-specific entities;
formatting the received event data to conform to a pre-defined format and aggregating the formatted event data;
receiving a plurality of ontological mappings and applying one or more of the ontological mappings to the aggregated event data to generate domain-specific event data, the ontological mappings identifying one or more relationships associated with the event data generated by two or more communicatively coupled domain-specific entities;
generating a first graph based on the domain-specific event data, the first graph including a first plurality of nodes representing the one or more domain-specific entities and a first plurality of edges representing the one or more relationships between two or more nodes sharing event data;
providing the first graph in a graphical user interface (GUI) and receiving, via the GUI, query input, the query input received as a natural language search query and causing the processor to generate a second graph including a second plurality of nodes and a second plurality of edges associated with the query input, the second plurality of nodes and the second plurality of edges different than the first plurality of nodes and the first plurality of edges in the first graph;
determining a first one or more recommendations to be provided via the GUI based on the received query input and the second plurality of nodes and the second plurality of edges included in the second graph; and
providing, via the GUI, the first one or more recommendations, the first one or more recommendations provided as a list of domain-specific entities and/or a list of relationships corresponding to the received query input and including auto-completion affordances to further determine a second one or more recommendations, the second one or more recommendations different than the first one or more recommendations.
